(19) United States
(12) Patent Application Publication
(10) Pub. No.: US 2003/0188622 A1
(43) Pub. Date: Oct. 9, 2003

(54) Musical instrument with multiple interchangeable stringed instruments

(76) Inventor: Scott Wilson, New York, NY (US)

Correspondence Address: Scott Wilson, 201 West 54th Street, New York, NY, 10019, US

(21) Appl. No.: 10/116,586

(22) Filed: Apr. 5, 2002

(51) Int. Cl. G10D 1/08

(52) U.S. Cl. 84/267

(57) ABSTRACT

This invention relates to stringed musical instruments; and more particularly to a novel combination of choices of three compact, portable stringed musical instruments attached to a single frame, allowing both immediate access and the possibility of playing any three combinations at the same time, of electric guitar, classical guitar, folk guitar, mandolin, banjo, bass, oud (Arabic guitar), saz (Turkish guitar), or bouzoukie (Greek mandolin). The novel design of these individual instruments allows the possibility of any of these individual instruments to be attached to existing standard electric and acoustic guitars and banjos, expanding the existing instrument into dual stringed instruments.

This invention relates to stringed musical instruments; and more particularly to a novel combination of choices of three compact stringed musical instruments attached to a single frame, allowing both immediate access and the possibility of playing any three combinations at the same time, of electric guitar, classical guitar, folk guitar, mandolin, banjo, bass, oud (Arabic guitar), saz (Turkish guitar), or bouzoukie (Greek mandolin). The novel design of these individual instruments allows the possibility of any of these individual instruments to be attached to existing standard electric and acoustic guitars and banjos, expanding the existing instrument into dual stringed instruments.

### BACKGROUND AND FIELD OF THE INVENTION

It has been proposed in the past to design stringed musical instruments with two or three permanently attached necks, allowing the performer instant access to several different guitars or basses. The instruments in this design are usually a permanent part of the instrument, and not removable, or switchable to form other combinations of musical stringed instruments.

To the best of my knowledge, no one has designed an electric stringed instrument system allowing for the capability of choosing any three combinations of electric guitar, classical guitar, folk guitar, mandolin, banjo, bass, oud (Arabic guitar), saz (Turkish guitar), or bouzoukie (Greek mandolin) to be placed in any order of preference on a single body frame. Specific to this body frame design are my compact, electric proposals for electric guitar, classical guitar, folk guitar, mandolin, banjo, bass, oud (Arabic guitar), saz (Turkish guitar), or bouzoukie (Greek mandolin). These instruments in the proposal do not have the standard full body or sound chamber, allowing for the possibility that they be grouped together on a single body frame.

To the best of my knowledge, no one has designed an acoustic guitar, acoustic mandolin, banjo, oud saz or bouzoukie with out any sound box, or body, other than a hollow space under the bridge, employing a peizo transducer, with a foam spacer mounted to a sound post suspended near the surface, producing a natural acoustic representation of the corresponding instrument.

### SUMMARY OF THE INVENTION

It is therefore an object of the present invention to provide for a novel musical stringed instrument which allows for the choice of two or three different compact stringed instruments of a novel design, including either an electric guitar, classical guitar, folk guitar, mandolin, banjo, bass, oud (Arabic guitar), saz (Turkish guitar), or bouzoukie (Greek mandolin), to be attached to a single frame body, allowing both immediate access and the possibility of playing the two or three combinations of different stringed instruments at the same time, in any preferred order.

It is a further object of the present electric guitar, classical guitar, folk guitar, mandolin, banjo, bass, oud (Arabic guitar), saz (Turkish guitar), or bouzoukie (Greek mandolin), that each instrument can be attached to an existing stringed instrument, expanding that instrument into two stringed instruments.

### BACKGROUND OF THE INVENTION

The invention relates generally to musical instruments, and more particularly to stringed instruments designed to have a choice of quick access to several instruments at once.

String musicians have long desired an instrument with double or triple necks of different instruments.

The usual attempt has been the combination of multiple stringed instruments combined into one instrument with two or more fixed position fingerboards. A search for prior instruments has revealed the following representative patents for a multi-necked string instrument listed below.

U.S. Pat. No. 5,918,294 to Karg discloses multiple guitars which interlock into each other. The Karg instruments specify only guitars, and do not include banjo, mandolin, bass, Arabic oud, Turkish saz, or Greek bouzoukie combinations. Also the Karg single instruments are not minimal, or light enough to be attached to existing acoustic or electric instruments. The Karg instruments attach to each other rather than to an independent frame. The sound of each instrument is more likely to resonate into the next instrument.

U.S. Pat. No. Des. 279,195 to Perkins discloses a three necked guitar. Three different stringed instruments are permanently attached to a single body. The types of stringed instruments, and the order are unchangeable. The individual instruments cannot be removed and attached to existing electric or acoustic stringed instruments.

U.S. Pat. No. 4,987,815 to Shockley discloses an acoustic and electric guitar combination. Two different stringed instruments are permanently attached to a single body. The types of stringed instruments, and the order are unchangeable. The individual instruments cannot be removed and attached to existing electric or acoustic stringed instruments.

### BRIEF DESCRIPTIONS OF THE DRAWINGS

FIG. 1 is a top plan view of a preferred embodiment of the invention withe the combination of 5 string banjo, guitar, and mandolin.

FIG. 2 is an exploded isometric view of the guitar component.

FIG. 3 is an exploded isometric view of the mandolin component.

FIG. 4 is the back view of the banjo, mandolin, guitar combination bolted to the frame

FIG. 5 Front view of the guitar component.

FIG. 6 Side view of the guitar component.

FIG. 7 Isometric view of the guitar component.

FIG. 8 Front view of the acoustic guitar, electric bass, and electric guitar combination.

FIG. 9 Front view of the 5 string banjo combination.

FIG. 10 Internal view of the electronic amplification of all the acoustic instruments.

FIG. 11 Front view of the Turkish Saz, Arabic Oud, and Greek Bouzoukie combination.

FIG. 12 Front view of the mandolin component attached to a standard acoustic guitar.

FIG. 13 Front view of the acoustic guitar component attached to a standard electric guitar.

FIG. 14 Front view of the electric guitar component.

### DETAILED DESCRIPTION OF THE PREFERRED EMBODIMENTS

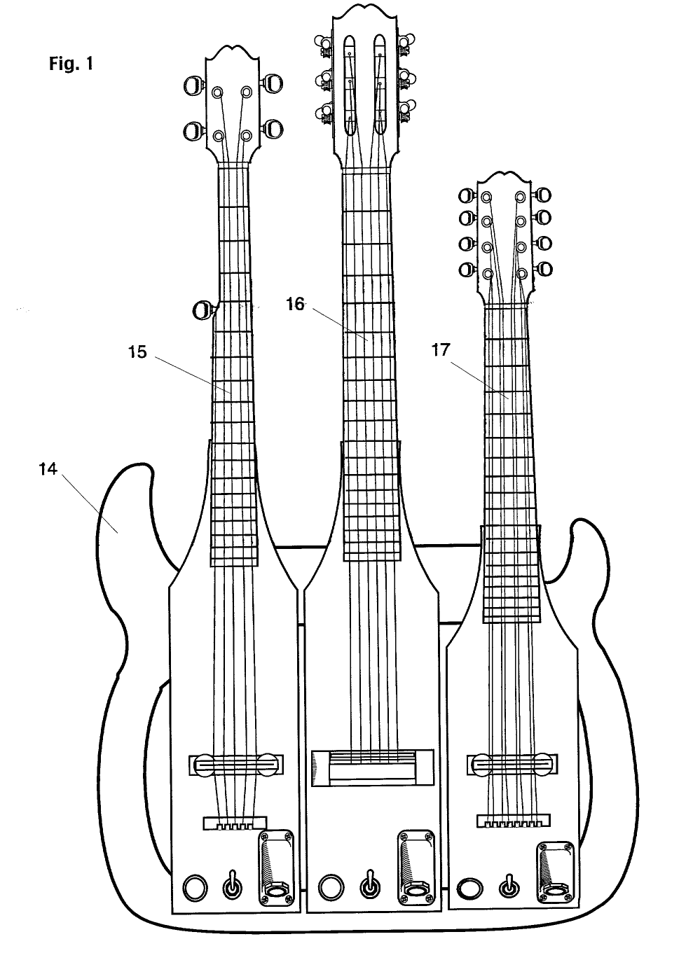

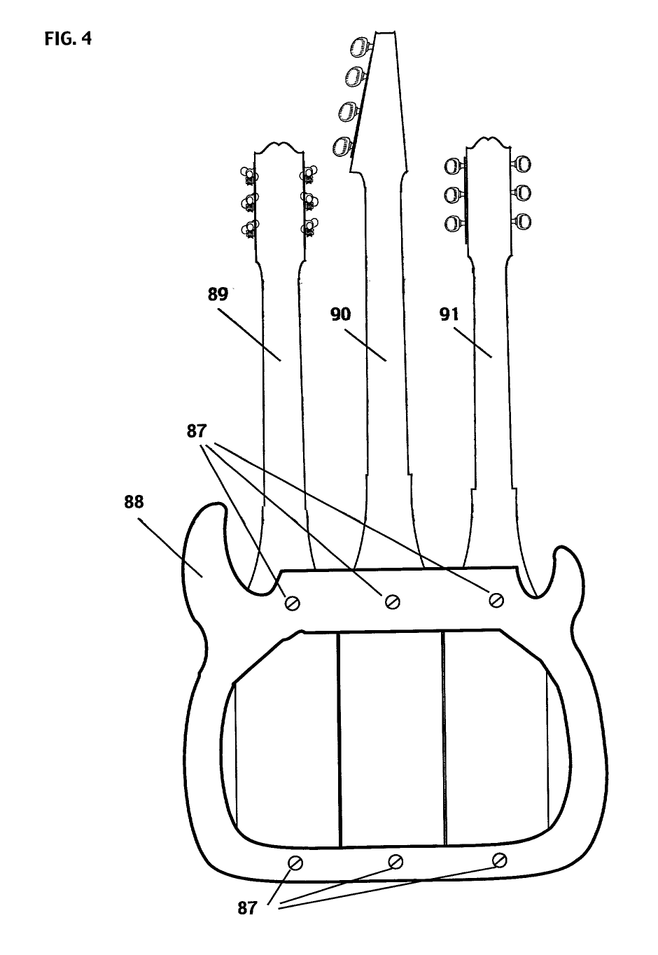

Referring now to FIG. 1 an embodiment of the present invention shows a front view of the 5 string banjo (15). acoustic guitar (16), and mandolin (17) attached to the wood frame (14). The instruments are held to the frame by two bolts (87) each shown in FIG. 4., which shows the back view of the invention.

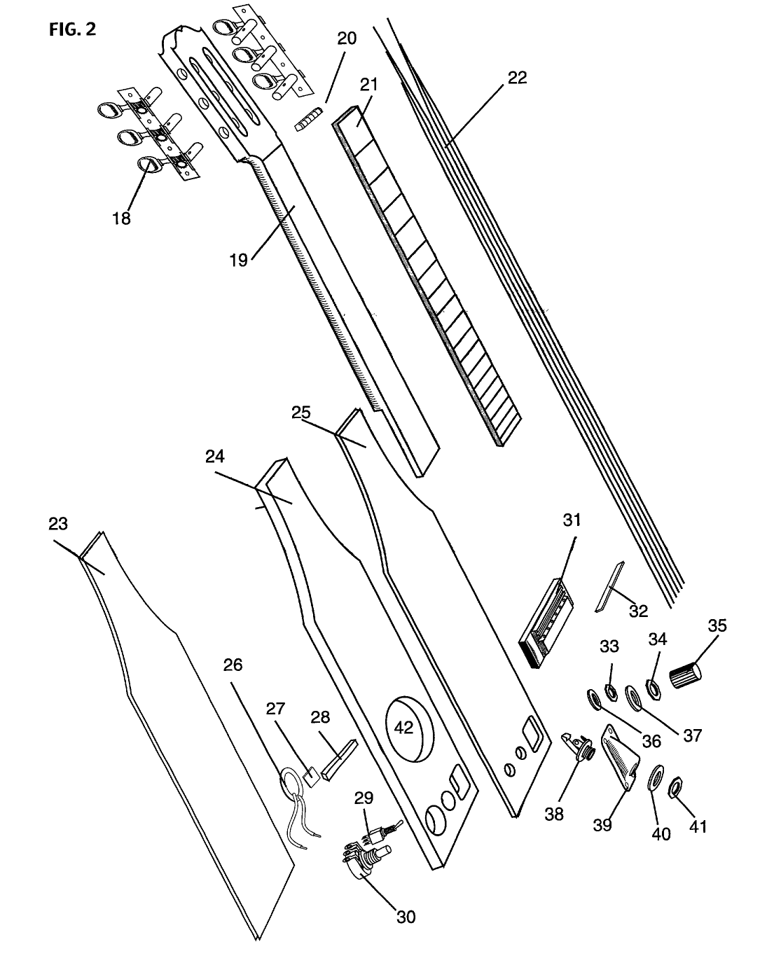

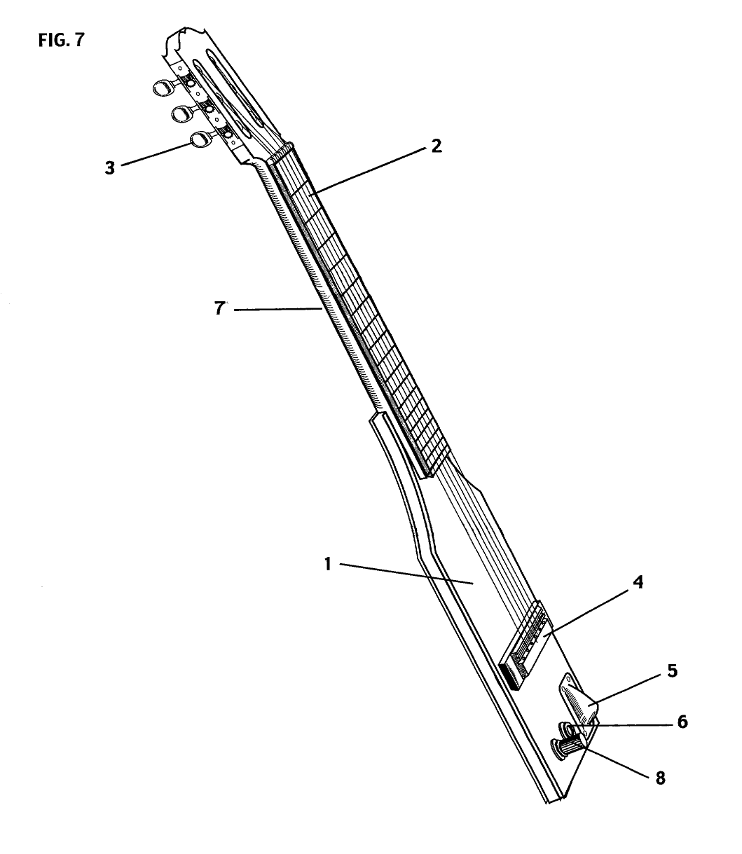

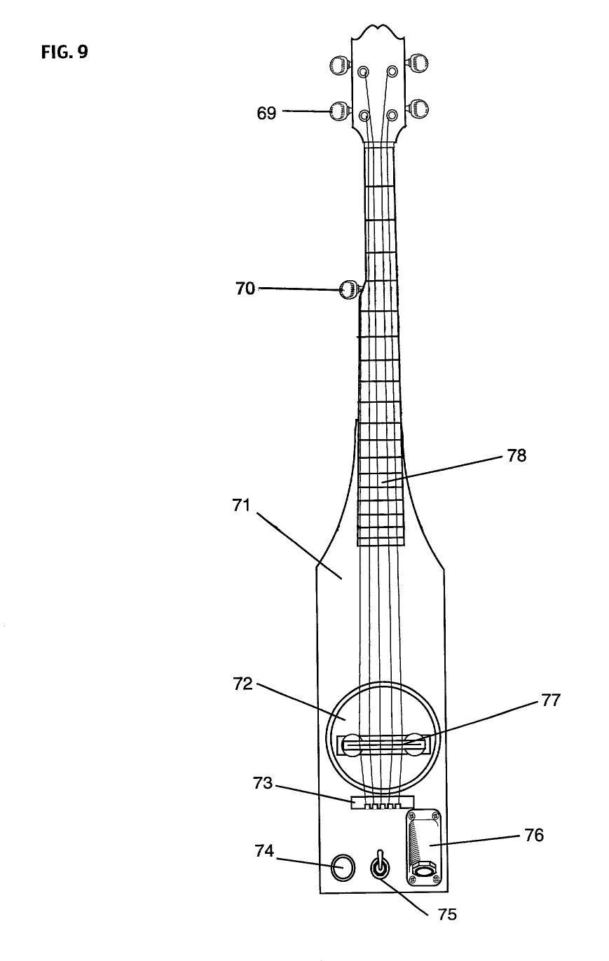

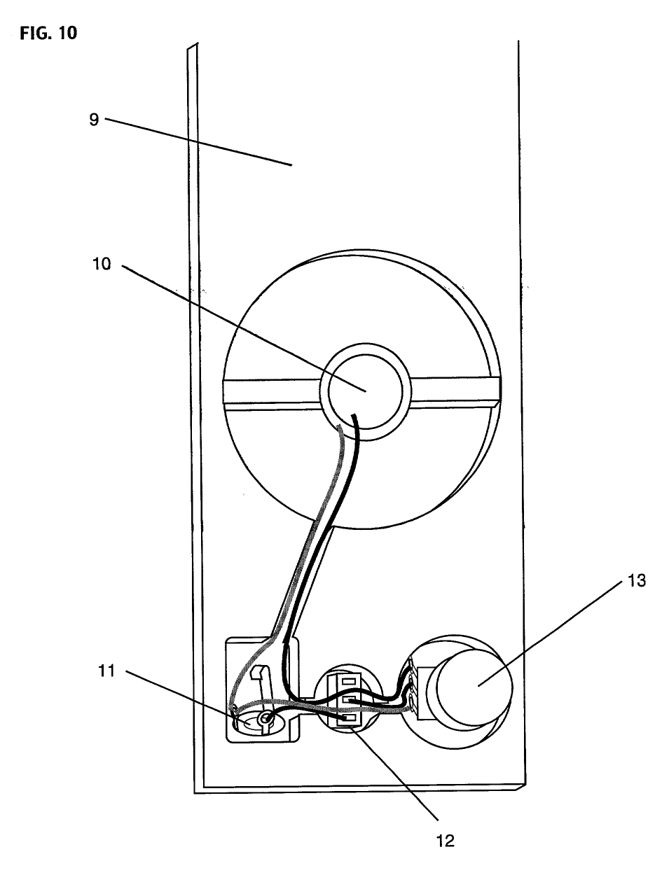

FIG. 2 shows the exploded view, for the construction of the guitar component if the invention. The guitar strings (22) are stretched across the instrument, held by tuning machines (18), and tied to the bridge (31) and saddle (32). The diagram shows the neck (19), fingerboard (21), and the nut (20) of the invention. The sound of the invention is transferred by the peizo-transducer (26) which is attached by means of foam tape (27) to a wood sound post (28) mounted in cavity (42) beneath the bridge (31). The output of the peizo transducer is controlled by the 100 k potentiometer (30), and the mute switch (29). The signal goes out to the 1/4 phone jack plug(38) mounted to the invention by jackplate (39) employing threaded nut ((41), and washer (40). 33-37 show the hardware and knob for the volume control (30) and mute switch (29). FIG. 9 illustrates the wiring diagram inside the acoustic cavity of the invention. FIG. 7 is the Isometric view of the guitar component.

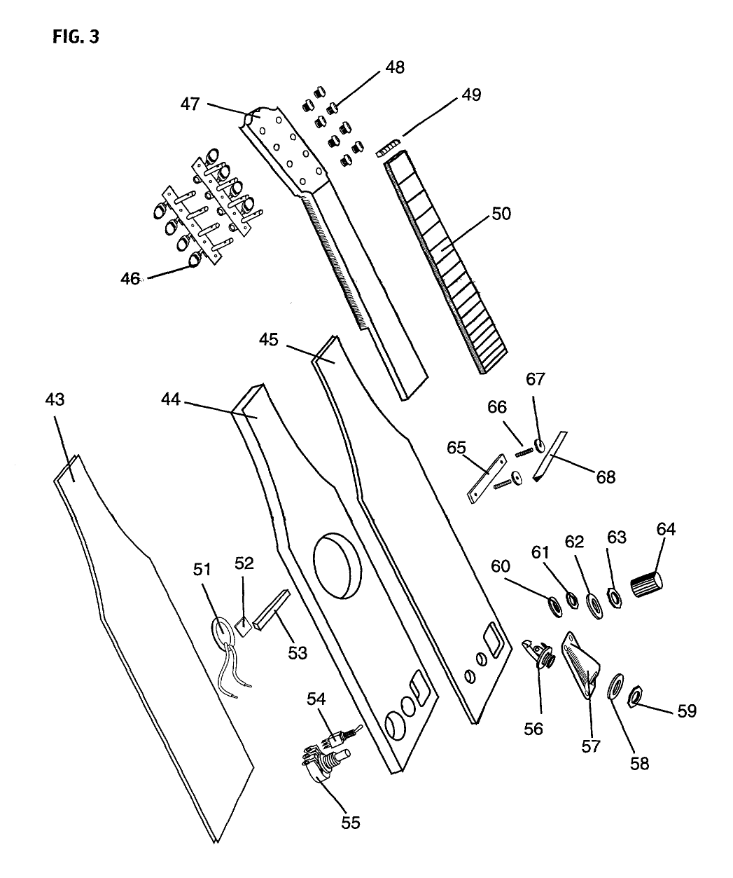

FIG. 3 is an embodiment of the isometric exploded view of the mandolin. The strings are tuned by machines (46). the parts of the mandolin component include-fingerboard (50), neck (47), peizo-transducer (51), potentiometer (55), bridge components 65-68, 1/′8″ wood back (43), 1/2″ sound board (44) spruce top (45), and volume control, and jack hardware 56-64.

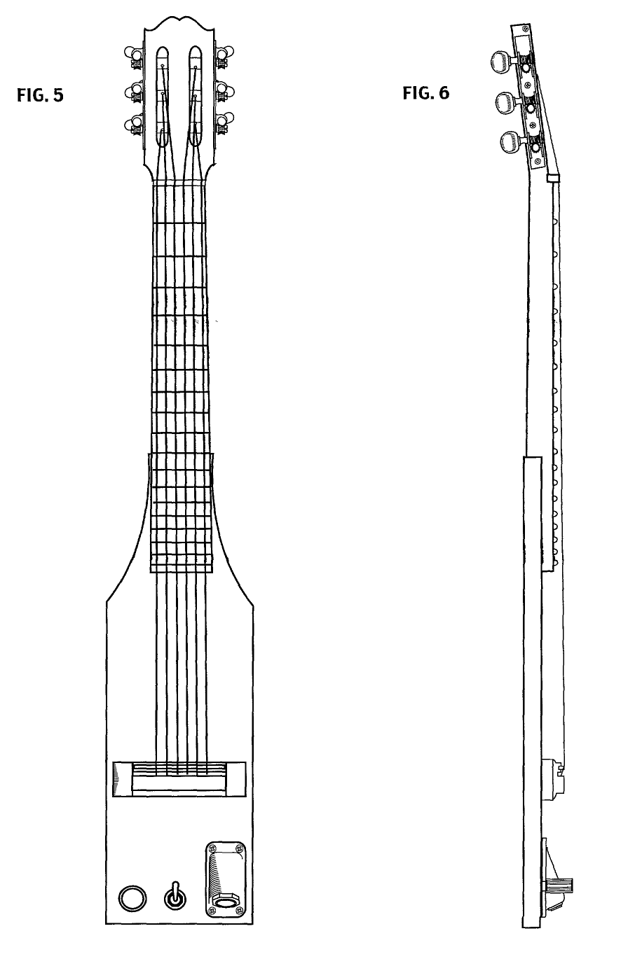

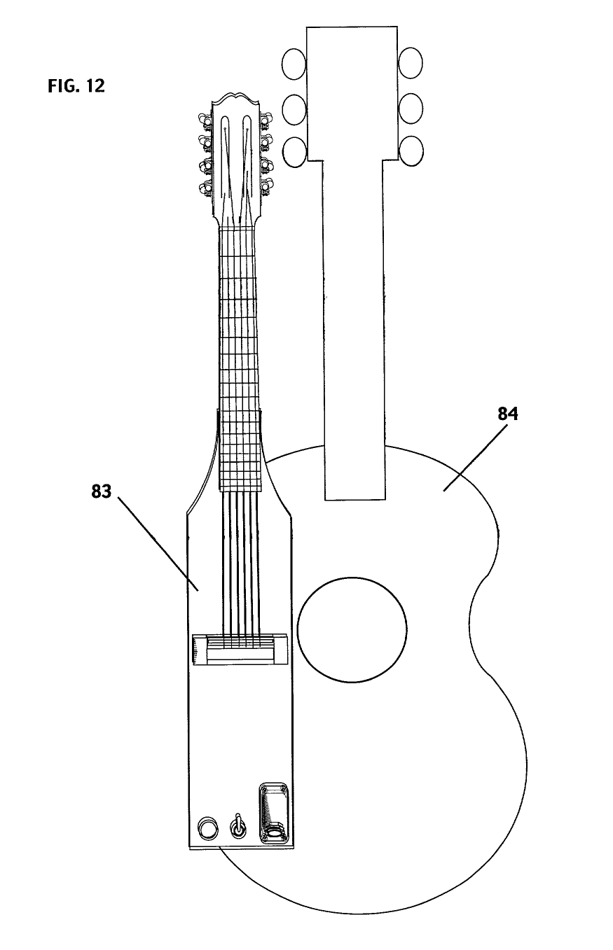

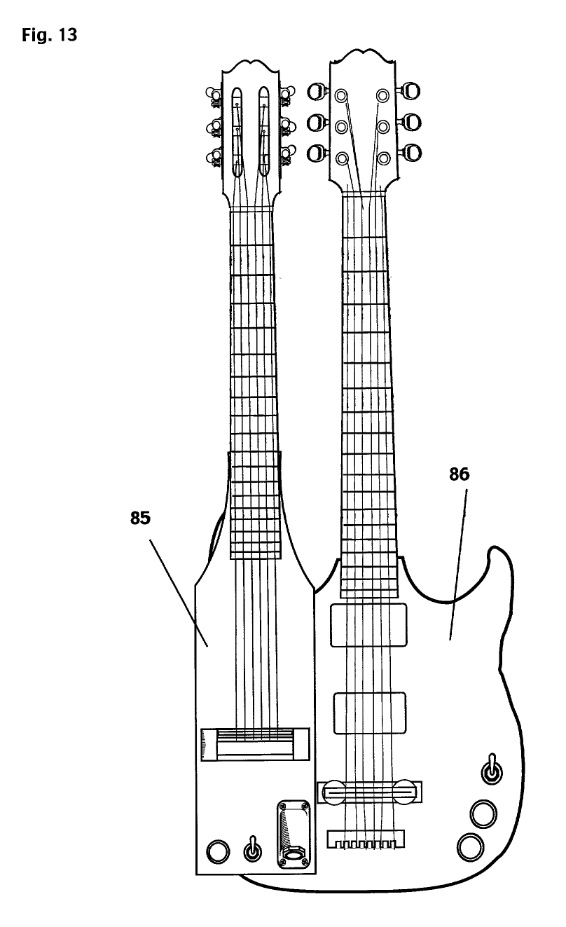

FIGS. 5 and 6 the invention's guitar component front and side. The narrow body as seen from the side view allows the instrument to be attached to other standard acoustic and and electric guitars by means of “velcro”, as shown in FIG. 12 which shows the mandolin component (83) attached to a standard acoustic guitar (84), or FIG. 13, which shows the acoustic guitar (85) component attached to an electric guitar (86).

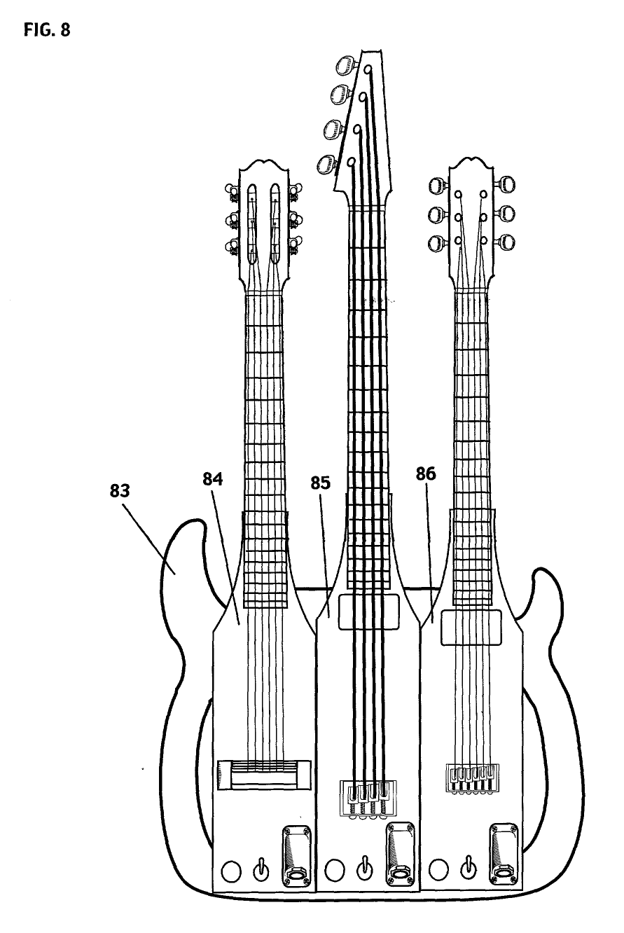

FIG. 8 shows the acoustic guitar (84), electric bass (85), and electric guitar (86) attached to wood frame (83).

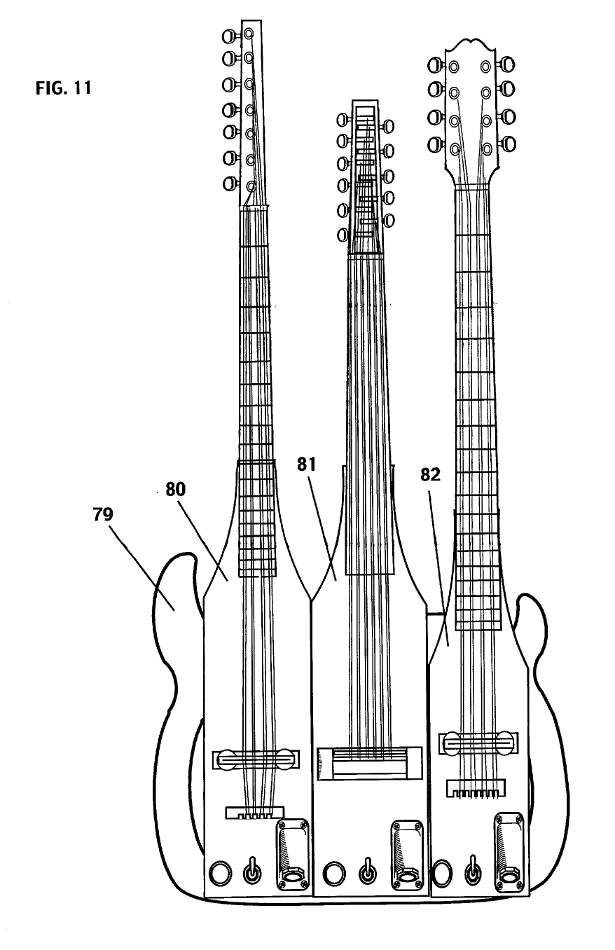

FIG. 11-front view of the embodiment of the invention of the Turkish Saz (81), Arabic Oud (82), and Greek bouzoukie (83) instrument combination mounted to the wood frame

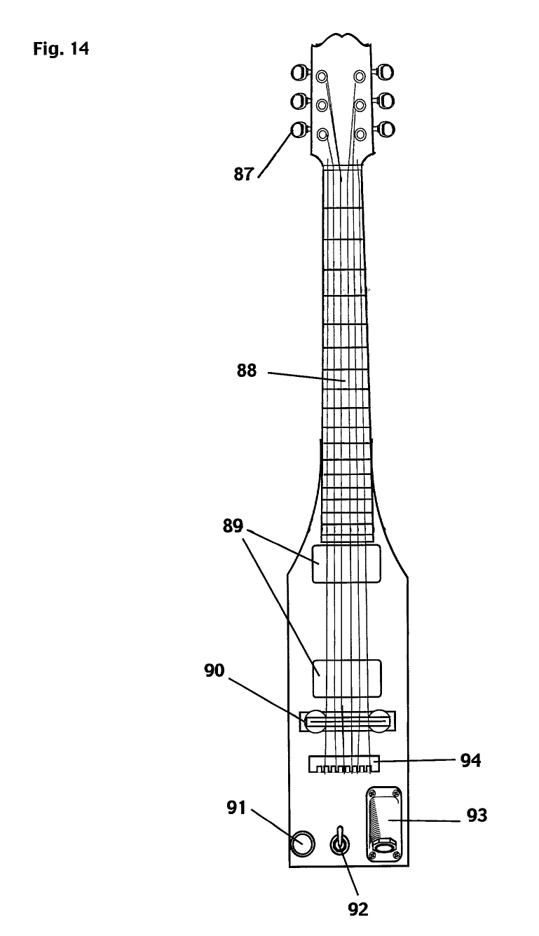

FIG. 14-describes the embodiment of the electric guitar component of the invention comprising of tuning machines (87), fingerboard (88), electromagnetic pickups (89), adjustable bridge (90), tail piece (94), volume control (91), mute switch (92), and jack plate (93).

The inventor claims:

1. A stringed musical instrument, comprising:
a wooden body,
a plurality of strings supported by the wooden base, and
at least one electro-magnetic pick-up or peizo-transducer mounted on said wood base to sense the musical vibrations produced by strumming the strings and conducted via the wooden base for conversion into musical sounds.

2. A musical instrument according to claim 1, where in the wood body consists of maple wood.

3. A musical instrument according to claim 1, where in the wood body consists of mahogany wood.

4. A musical instrument according to claim 1, where in the wood body consists of ash wood.

5. A musical instrument according to claim 1, where in said strings extend across support members comprising a bridge, a finger board, and a nut.

6. A musical instrument according to claim 1, where in a guitar, a banjo, and a mandolin are attached to a single wood frame.

7. A musical instrument according to claim 1, and 2, where in the guitar has at least one electromagnetic pick-up, the banjo, and mandolin each have a peizo-electric pickup.

8. A musical instrument according to claim 1, and 2, where in the Bouzoukie and Saz have at least one electromagnetic pick-up, the Oud a peizo-electric pick-up.

9. A musical instrument according to claim 1, and 2, where in the bass guitar and the electric guitar have at least one electromagnetic pick-up, and the folk guitar has a peizo-electric pick-up.

10. A musical instrument where any 2 or 3 instruments, either the banjo, mandolin, electric guitar, folk guitar, bass, oud, saz, or bouzoukie can be mounted in any order to a single wooden frame.

11. A musical instrument with the capability of being attached to most standard acoustic or electric guitars.

12. A musical instrument combination attached to a single wood frame body with a guitar, 5 string banjo, and mandolin.

13. A musical instrument combination attached to a single wood frame body with a guitar, Arabic oud, and Turkish saz.

14. A musical instrument combination attached to a single wood frame body with a guitar, Arabic oud and Greek bouzoukie.

15. A musical instrument combination attached to a single wood frame body with a guitar, bass and mandolin.

16. A musical instrument combination attached to a single wood frame body with an electric bass, electric guitar, and a Turkish saz.

17. A musical instrument combination attached to a single wood frame body with a guitar, Greek bouzoukie, and mandolin.

18. A musical instrument combination attached to a single wood frame body with an electric guitar, Arabic oud, and mandolin.
